(19) United States
(12) Patent Application Publication
(10) Pub. No.: US 2014/0308599 A1
(43) Pub. Date: Oct. 16, 2014

(54) GASKET DEVICE FOR A FUEL CELL STACK

(71) Applicant: Hyundai Motor Company, Seoul (KR)

(72) Inventors: Byeong-Heon Jeong, Seongnam-si (KR); Bo-Ki Hong, Seoul (KR)

(73) Assignee: HYUNDAI MOTOR COMPANY, Seoul (KR)

(21) Appl. No.: 13/971,324

(22) Filed: Aug. 20, 2013

(30) Foreign Application Priority Data
Apr. 15, 2013 (KR) 10-2013-0041313

(51) Int. Cl. H01M 8/24

(52) U.S. Cl. CPC H01M 8/242
USPC 429/457; 429/508; 429/510

(57) ABSTRACT

Provided is a gasket device for a fuel cell stack in which gaskets of different materials are integrally molded in an anode separator (or an anode gas diffusion layer) and a cathode separator (or a cathode gas diffusion layer) to provide sealing stability at low temperatures and long-term stability at high temperatures in a fuel cell integrated with a conventional single material and evenly securing the required physical properties of the fuel cell stack gasket.

### CROSS-REFERENCE TO RELATED APPLICATION

This application claims under 35 U.S.C. §119(a) the benefit of Korean Patent Application No. 10-2013-0041313 filed on Apr. 15, 2013, the entire contents of which are incorporated herein by reference.

### BACKGROUND

(a) Technical Field

The present disclosure relates to a gasket device for a fuel cell stack, which simultaneously improves cell sealing properties at low temperatures and long-term use stability at high temperatures.

(b) Background Art

One well known fuel cell that is typically used to power vehicles is a Polymer Electrolyte Membrane Fuel Cells (PEMFCs). In PEMFCs, to maintain a proper seal for the reaction gas, hydrogen/air, and coolant in a fuel cell stack a gasket typically provided for each cell.

In order a gasket to be used in a stack for fuel cell vehicles, powered by hydrogen, the gasket generally has to satisfy various required physical properties in order to be for the fuel cell to function properly, (e.g., within a certain range of hardness, excellent elasticity or very low compression set, superior mechanical properties, superior resistances to acid and hydrolysis, low diffusivity and permeability with respect to hydrogen/air (or oxygen)/coolant, a low content of impurities that may cause catalyst poisoning, superior thermal resistances, high electrical insulation, superior productivity, low price, etc.).

In general, polymeric elastomers, which satisfy the above physical properties and are widely used as a gasket for a fuel cell stack, may be classified into fluoroelastomers, silicone elastomers, and hydrocarbon elastomers. The fluoroelastomers are roughly classified in the American Society for Testing and Materials (ASTM) into FKM and FFKM, and have been widely used for various applications such as for vehicles, in the architectural field, petrochemical industries, and so on.

In particular, the fluoroelastomers have received a significant amount of attention due to its lengthened durability under severe operating conditions of hydrogen fuel cell vehicles. However, fluoroelastomers typically have poor properties of injection molding, poor cold resistance and are relatively more expensive than other elastomers.

Silicone elastomers may be classified into general silicone elastomers such as polydimethylsiloxane and modified silicone elastomers such as fluorosilicone. The silicone elastomers may also be used in a solid state, but liquid silicone rubber is often used for precision injection molding and thus has excellent injection molding performance. However, during operation of the fuel cells, silicone impurities are extracted and eventually poison the platinum catalysts, causing the catalyst to become defective.

Hydrocarbon elastomers, such as Ethylene-Propylene Diene Monomer (EPDM), Ethylene-Propylene Rubber (EPR), Isoprene Rubber (IR), and Isobutylene-Isoprene Rubber (IIR), have also been used as an alternative gasket material by vehicular manufactures. However, hydrocarbon elastomers have degraded physical properties at temperatures higher than 100° C. and thus it is difficult to use this material in long term applications, in spite of its superior cold resistance and low price.

FIG. 1 is a schematic diagram illustrating a structure of a conventional fuel cell stack. Referring to FIG. 1, the fuel cell stack includes a Membrane Electrode Assembly (MEA) 2, anode and cathode Gas Diffusion Layers (GDLs) 3 and 4, anode and cathode separators 5 and 6, anode and cathode gaskets 7 and 8, and other stacking components. In the MEA 2, a catalytic electrode layer where electrochemical reaction occurs is attached to both sides of an electrolyte membrane 1 where protons are exchanged. The anode and cathode GDLs 3 and 4 are disposed on both surfaces of the MEA 2 to uniformly distribute reaction gases and deliver generated electrical energy accordingly. More specifically, the anode and cathode separators 5 and 6 provide pathways for the reaction gases and a coolant to the anode and cathode GDLs 3 and 4, and the anode and cathode gaskets 7 and 8 are disposed between the MEA 2 and the anode and cathode separators 5 and 6 to seal therein the reaction gases and the coolant and provide a proper stacking pressure.

The anode and cathode gaskets 7 and 8 are integrated with the anode and cathode separators 5 and 6 through an injection molding process, and both gaskets are made of a single material, for example, either a fluoroelastomer, a silicone elastomer, or a hydrocarbon elastomer. When gaskets 7 and 8 are made of a fluoroelastomer, the gasket provides superior stability for a long period of time at high temperatures, but shows poor cell sealing stability at low temperatures and is not easily mass produced due to its increased cost. When a low-price hydrocarbon elastomer is used as a material of the gaskets 7 and 8, excellent cost reduction is provided, but the physical properties of the gasket are greatly reduced over long-term use at high temperatures. Finally, when a silicone elastomer is used as a material of the gaskets 7 and 8, superior injection molding properties are provided, but in an operating environment of a fuel cell stack, silicone-based impurities are extracted and eventually decrease the overall cell performance.

Meanwhile, use of two or more kinds of rubber or resin materials that combine advantages of different gasket materials as a gasket for fuel cells has also been considered.

For example,

(1) Japanese Patent Application Publication Gazette No. 2003-157866 (hereinafter, referred to as Patent Document 1) discloses a gasket integrated with a separation plate or an electrolyte membrane that are fuel cell components, in which a rubber material having low gas permeability is used for sealing of a gas flow path and a rubber material having high gas permeability is used for sealing of a coolant flow path; and

(2) Japanese Patent Application Publication Gazette No. 2004-55428 (hereinafter, referred to as Patent Document 2) discloses a gasket integrated with a separation plate, a gas diffusion layer, or a membrane electrode assembly that are fuel cell components, in which at least two kinds of rubber or resin materials are combined (that is, a first layer bonded to the component and a second layer for covering the first layer are provided).

Such conventional techniques are not likely to be practical and have numerous problems which are described below. In Patent Document 1, two or more kinds of gasket materials have to be integrated together with a fuel cell component, thus the manufacturing process is quite complicated. In addition, each gasket material has different optimal molding and crosslinking conditions, such that when different gasket materials are manufactured in the same injection molding and crosslinking conditions, both of them may not show sufficient required physical properties as would be expected.

Also in Patent Document 2, a gasket having two layers (which are composed of different gasket materials) is integrated with a fuel cell component, such that in the two-layer gasket structure, interlayer interfacial adhesion is not particularly good and when a second gasket layer is injection-molded on a first gasket layer, resistance to the flow of the second gasket material on the surface of the first layer gasket material is higher than is desirable, making it difficult to obtain a good molding product. Moreover, like in Patent Document 1, when the same molding and crosslinking conditions are provided, both of the first gasket layer and the second gasket layer may not show sufficient required physical properties.

### SUMMARY OF THE DISCLOSURE

The present invention provides a gasket device for a fuel cell stack, in which a gasket of different materials is integrated with an anode and a cathode gas diffusion layer or separators, thereby improving stack's sealing stability at low temperatures and improves stability over long-term use at high temperatures simultaneously.

The present invention also provides a gasket device for a fuel cell stack, which integrates a fuel cell component with a first kind of a gasket material and another fuel cell component with a second kind of a gasket material, and in this way, integration for each gasket material is performed separately under suitable conditions for that corresponding material, thereby sufficiently guaranteeing the various physical properties required for a fuel cell at the same time.

According to an aspect of the present invention, there is a gasket device for a fuel cell stack including gas diffusion layers including an anode gas diffusion layer and a cathode gas diffusion layer, an anode separator and a cathode separator, and an anode gasket and a cathode gasket that are integrated with the anode gas diffusion layer and the cathode gas diffusion layer, respectively, wherein the anode gasket and the cathode gasket are composed of different materials.

According to another aspect of the present invention, there is a gasket device for a fuel cell stack including gas diffusion layers that includes an anode gas diffusion layer and a cathode gas diffusion layer, separators having an anode separator and a cathode separator, and an anode gasket and a cathode gasket that are integrated with the anode separator and the cathode separator, respectively, in which the anode gasket and the cathode gasket are composed of different materials.

According to another aspect of the present invention, there is a gasket device for a fuel cell stack including gas diffusion layers including an anode gas diffusion layer and a cathode gas diffusion layer, separators having an anode separator and a cathode separator, an anode gasket that is integrated with the anode gas diffusion layer and the anode separator, and a cathode gasket that is integrated with the cathode gas diffusion layer and the cathode separator, wherein the anode gasket and the cathode gasket are composed of different materials.

More specifically, the anode gasket and the cathode gasket may be composed of different materials selected from a group consisting of a fluoroelastomer, a silicone elastomer, and a hydrocarbon elastomer. In particular, the fluoroelastomer may be composed of one of or a mixture of FKM and FFKM, the silicone elastomer may be composed of one of or a mixture of polydimethylsiloxane and fluorosilicone, and the hydrocarbon elastomer may be composed of one of or a mixture of EPDM, EPR, IR, and IIR.

In some of the above embodiments, the anode gasket and the cathode gasket may be formed to have one of a general shape in which the anode gasket and the cathode gasket are integrated into upper and lower portions being located in a peripheral region of the anode and cathode separators, an encapsulation shape in which the anode gasket and the cathode gasket encapsulate upper and lower portions of and sides of the anode and cathode separators, and a hybrid shape that is a combination of the general shape and the encapsulation shape.

Advantageously, by integrating different materials with different components, the anode gasket and the cathode gasket may be manufactured in optimal molding and crosslinking conditions for each material respectively. As such, the anode gasket and the cathode gasket may be separately manufactured to have different colors.

### BRIEF DESCRIPTION OF THE DRAWINGS

The above and other features of the present invention will now be described in detail with reference to an exemplary embodiment thereof illustrated the accompanying drawings which are given hereinbelow by way of illustration only, and thus are not limitative of the present invention, and wherein:

FIG. 1 is a schematic diagram illustrating a structure of a conventional fuel cell stack;

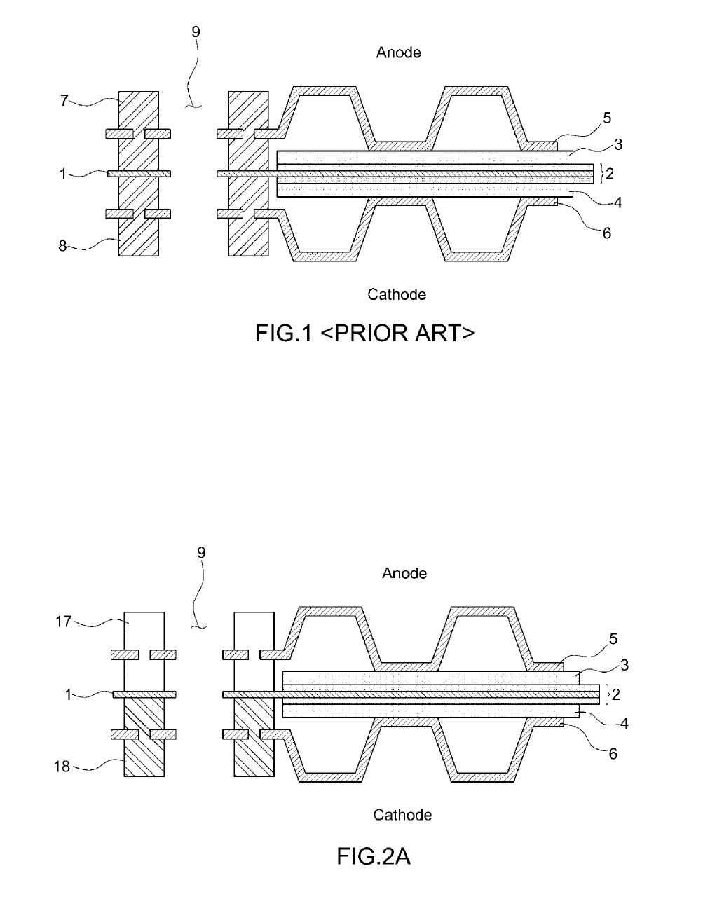

FIGS. 2A and 2B are schematic diagrams illustrating a general shape of a gasket device according to a first exemplary embodiment of the present invention;

FIGS. 3A and 3B are schematic diagrams illustrating an encapsulation shape of a gasket device according to a second exemplary embodiment of the present invention;

FIGS. 4A and 4B are schematic diagrams illustrating a hybrid shape of a gasket device according to a third exemplary embodiment of the present invention;

FIGS. 5A and 5B are cross-sectional views illustrating an integrated gasket with a gas diffusion layer according to an exemplary embodiment of the present invention; and

FIGS. 6A and 6B are cross-sectional views illustrating an integrated gasket with a separator and a gas diffusion layer according to an exemplary embodiment of the present invention.

### DETAILED DESCRIPTION

Hereinafter, the present invention will be described in detail with reference to the accompanying drawings to allow those of ordinary skill in the art to easily carry out the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and fuel cell vehicles. As referred to herein, a hybrid vehicle is a vehicle that has two or more sources of power, for example both fuel cell and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.

The present invention integrates a gasket of different materials with the separators, thereby improving the stack's sealing stability at low temperatures and the long-term use stability at high temperatures simultaneously. The present invention may use a conventional injection molding machine to integrate a gasket integrally with separators without any change or modification to the manufacturing equipment. To integrate the gasket of different materials to the separators, an injection molding process may be applied or a bonding process may be used.

A gasket material having good low temperature (e.g., −30° C. or less) characteristics may be used to improve gasket's sealing at low temperatures, and a gasket material having good high-temperature elasticity may be used to improve gasket's oxidation resistance at high temperatures (e.g., 120° C. or more), thereby improving the sealing performance at low temperatures and the long term stability at high temperatures at the same time.

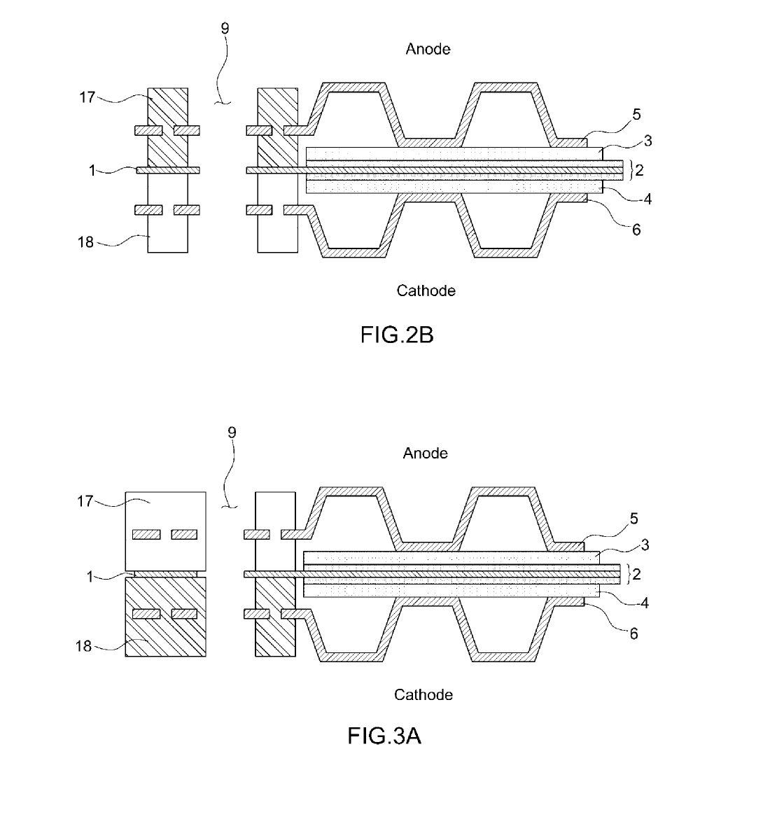

FIGS. 2A and 2B are schematic diagrams illustrating a general shape of a gasket device according to a first embodiment of the present invention. In the first embodiment of the present invention, gaskets 17 and 18 are integrally molded to separators 5 and 6 through an injection molding process when a cell of a fuel cell stack is configured. The separators 5 and 6 may be an anode separator 5 and a cathode separator 6, and the gas diffusion layers 3 and 4 may be an anode gas diffusion layer 3 and a cathode gas diffusion layer 4. Likewise, the gaskets 17 and 18 may be embodied as an anode gasket 17 and a cathode gasket 18.

The anode gasket 17 and the cathode gasket 18 may be integrally molded to the anode separator 5 and the cathode separator 6 by an injection machine separately provided for an anode and a cathode. Preferably, the gasket 17, the separator 5, and the gas diffusion layer 3 in the anode and the gasket 18, the separator 6, and the gas diffusion layer 4 in the cathode are separated from each other a certain distance.

Herein, the anode and the cathode have different environments and operating conditions and different reaction and transport phenomena occur in the anode and the cathode, and therefore, it is desirable to use suitable materials for the anode and the cathode, respectively. In particular, the gasket device according to the first embodiment of the present invention includes the anode gasket 17 and the cathode gasket 18 each having different materials which are integrally formed to the anode separator 5 and the cathode separator 6, respectively.

Referring to FIG. 2A, the anode gasket 17 may be made of a fluoroelastomer which is integrated with the anode separator 5 and the cathode gasket 18 may be made of a hydrocarbon elastomer which is integrated with the cathode separator 6 by means of an injection molding process, respectively.

In another embodiment illustrated in FIG. 2B, the anode gasket 17 may be made of a hydrocarbon elastomer which is integrated with the anode separator 5 and the cathode gasket 18 may be made of a fluoroelastomer which is integrated with the cathode separator 6, by means of an injection molding process, respectively.

The shapes of the gaskets illustrated in FIGS. 2A and 2B may be a general shape in which the gaskets 17 and 18 are integrated into upper and lower portions located in a peripheral region of the separators 5 and 6 and thus cell is sufficiently sealed. In this case, the peripheral edges of the separators 5 and 6 are exposed.

A gasket that is made of a fluoroelastomer is sufficiently stable at high temperatures and the gasket which is made of the hydrocarbon elastomer contributes to the improvement of cold resistance and is able to reduce costs since that gasket is not exposed to high temperatures. Various gasket materials described below may also be implemented as well as the gasket structures illustrated in FIGS. 2A and 2B. The anode gasket 17 of the fluoroelastomer may be integrated with the anode separator 5, and the cathode gasket 18 of the silicone elastomer may be integrated with the cathode separator 6 by means of an injection molding process, respectively. The anode gasket 17 of the silicone elastomer may be integrated with the anode separator 5, and the cathode gasket 18 of the fluoroelastomer may be integrated with the cathode separator 6 by means of an injection molding process, respectively. In this case, the fluoroelastomer contributes to long term stability improvement and the improvement of resistance to extraction of impurities at high temperatures, and the silicone elastomer gasket contributes to improvement of injection molding properties.

In addition, the anode gasket 17 of the hydrocarbon elastomer material may be integrated with the anode separator 5 and the cathode gasket 18 of the silicone elastomer material may be integrally integrated with the cathode separator 6. Alternatively, the anode gasket 17 of the silicone elastomer material may be integrated with the anode separator 5, and the cathode gasket 18 of the hydrocarbon elastomer material may be integrated with the cathode separator 6 by means of an injection molding process, respectively. In this case, the gasket of the hydrocarbon elastomer improves the sealing stability at low temperatures and reduces the cost of the gasket, and the silicone elastomer material gasket improves injection molding properties.

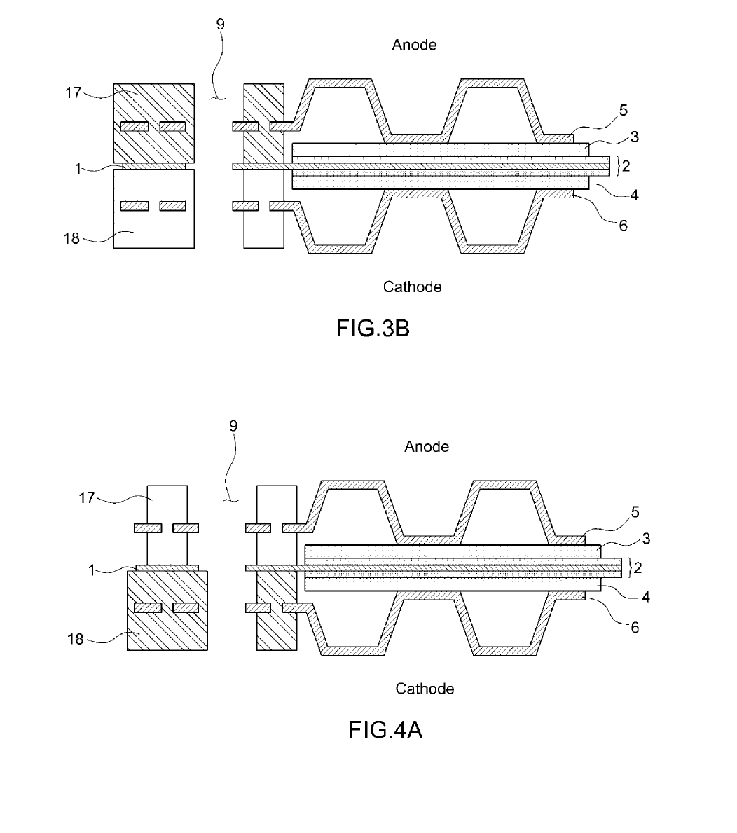

FIGS. 3A and 3B are schematic diagrams illustrating an encapsulation shape of a gasket device according to a second exemplary embodiment of the present invention. The second exemplary embodiment of the present invention is similar to the foregoing first embodiment in a sense that the gaskets 17 and 18 of different materials are molded integrally with the anode and cathode separators 5 and 6 respectively, and thus will not be described in detail. However, the first embodiment and the second embodiment are different from each other in that the shapes of the gaskets 17 and 18 according to the first exemplary embodiment are a general shape, but the shapes of the gaskets 17 and 18 according to the second exemplary embodiment are an encapsulation shape.

The encapsulation shape refers to a shape in which the gaskets 17 and 18 encapsulate the separators 5 and 6. In other words, the gaskets 17 and 18 illustrated in FIGS. 2A and 2B are integrated into only upper and lower surfaces of the peripheral edge portions of the separators 5 and 6 and thus the sides of the peripheral edge portions of the separators 5 and 6 are exposed. However, the gaskets 17 and 18 illustrated in FIGS. 3A and 3B encapsulate not only the upper and lower portions of, but also the sides of the separators 5 and 6, such that the sides are not exposed.

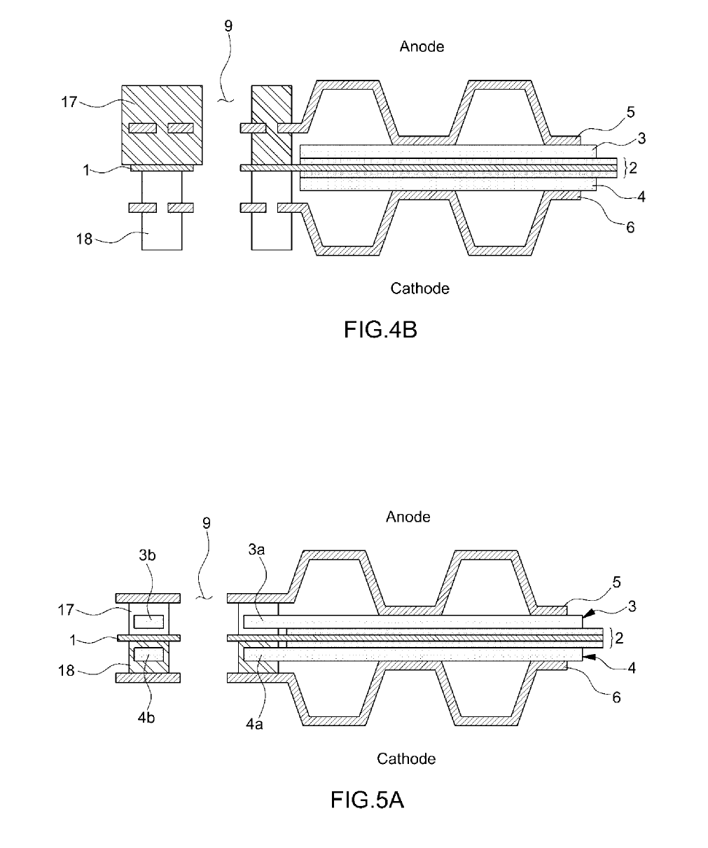

FIGS. 4A and 4B are schematic diagrams illustrating a hybrid shape of a gasket device according to a third exemplary embodiment of the present invention. The third exemplary embodiment of the present invention is similar with the foregoing first embodiment in a sense that the gaskets 17 and 18 of different materials are integrated with the anode and cathode separators 5 and 6 by means of an injection molding process, respectively. However, the gaskets 17 and 18 according to the third exemplary embodiment of the present invention have a hybrid shape in which a general shape and an encapsulation shape are combined.

For example, as illustrated in FIG. 4A, the anode gasket 17 is integrated with the anode separator 5 to have a general shape, that is, the anode gasket 17 is integrated into upper and lower portions located in a peripheral region of the anode separator 5, and the cathode gasket 18 is integrated with the cathode separator 6 to have an encapsulation shape, that is, the cathode gasket 18 is formed to encapsulate all of the upper and lower portions of and the sides of the edge portions located in a peripheral region of the cathode separator 6.

As illustrated in FIG. 4B, the anode gasket 17 is integrated with the anode separator 5 to have an encapsulation shape. That is, the anode gasket 17 is formed to encapsulate all of the upper and lower portions of and the sides of the edge portions located in a peripheral region of the anode separator 5, and the cathode gasket 18 is integrated with the cathode separator 6 to have a general shape. That is, the cathode gasket 18 is formed on the upper and lower portions located in a peripheral region of the cathode separator 6.

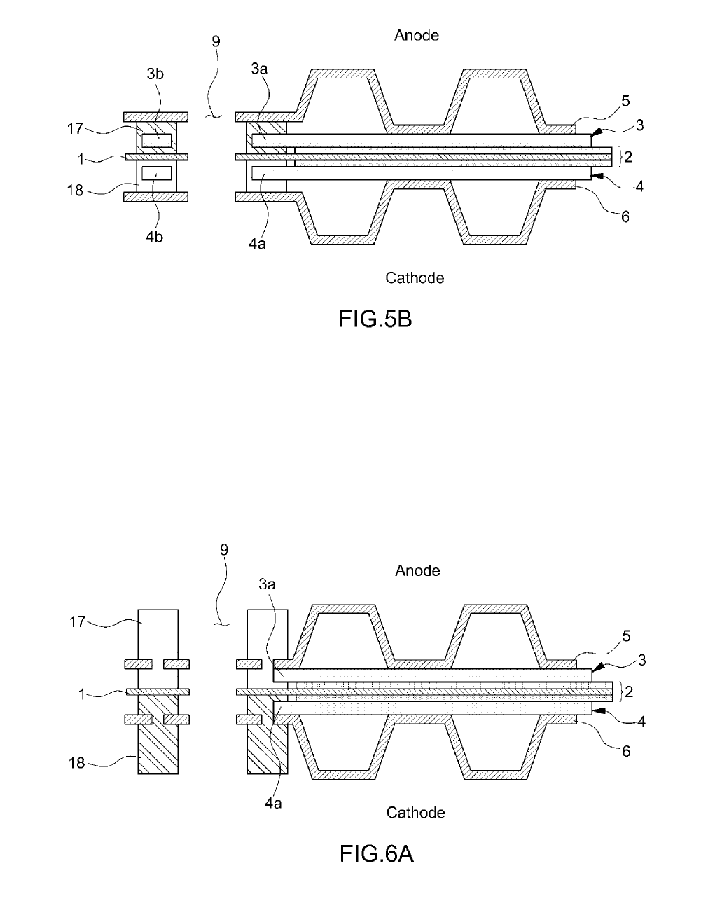

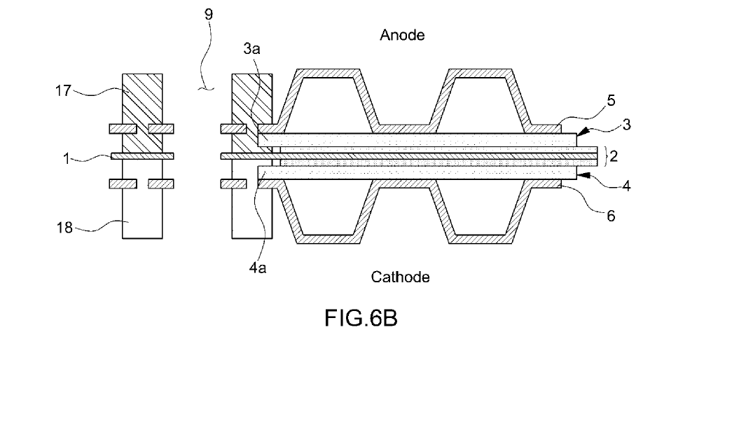

The anode gasket 17 and the cathode gasket 18 are described as being integrated with the anode and cathode separators 5 and 6, respectively, as illustrated in FIGS. 2A through 4B, but the anode and cathode gaskets 17 and 18 may also be integrated in the anode and cathode gas diffusion layers 3 and 4 as illustrated in FIGS. 5A and 5B or the anode gasket 17 may be integrated in the anode gas diffusion layer 3 and the anode separator 5 and the cathode gasket 18 may be integrated in the cathode gas diffusion layer 4 and the cathode separator 6 as illustrated in FIGS. 6A and 6B without departing from the overall concept of the present invention.

FIGS. 5A and 5B are cross-sectional views illustrating an integrated gasket with a gas diffusion layer according to the exemplary embodiment of the present invention. The anode and cathode gas diffusion layers 3 and 4 according to the exemplary embodiment illustrated in FIGS. 5A and 5B further include extension portions 3a, 3b, 4a, and 4b that may further extend from the gas diffusion layer main bodies on the same plane in an edge direction (or a longitudinal direction).

Herein, however, the main bodies of the gas diffusion layers 3 and 4 refer to gas diffusion layers having the same size as the gas diffusion layers 3 and 4 illustrated in FIGS. 2A through 4B.

The extension portions 3a, 3b, 4a, and 4b may include first extension portions 3a and 4a that further extend from the gas diffusion layer main bodies toward a manifold 9 and second extension portions 3b and 4b that further extend from the first extension portions 3a and 4a outwardly from the manifold 9, having the manifold 9 between the first extension portions 3a and 4a and the second extension portions 3b and 4b. The second extension portions 3b and 4b however are optional and are not necessary in all embodiments of the present invention.

However, when the second extension portions 3b and 4b are formed, their rigidity is further improved; when the second extension portions 3b and 4b are not formed, the usage of gas diffusion layers 3 and 4 may be reduced, resulting in cost reduction.

The gas diffusion layer-integrated gaskets 17 and 18 include the anode gasket 17 and the cathode gasket 18. This anode gasket 17 may be disposed between the membrane electrode assembly 2 and the anode separator 5 and may be integrally formed to enclose the entirety of upper and lower portions and sides of the extension portions 3a and 3b of the anode gas diffusion layer 3. The cathode gasket 18 may be disposed between the membrane electrode assembly 2 and the cathode separator 6 and may be integrally formed to enclose all of upper and lower portions and sides of the extension portions 4a and 4b of the cathode gas diffusion layer 4.

FIGS. 6A and 6B are cross-sectional views illustrating an integrated gasket with a separator and a gas diffusion layer according to the exemplary present invention. The manifold 9 of the separators 5 and 6 according to the exemplary embodiment of FIGS. 6A and 6B is disposed on the bottom surface and on the same plane without a step with the bottom surface of a flow path, and the gas diffusion layers 3 and 4 according to the embodiment of FIGS. 6A and 6B further include the extension portions 3a and 4a that extend from the gas diffusion layer main bodies toward the manifold 9.

The separator and gas diffusion layer integrated gaskets 17 and 18 may include the anode gasket 17 and the cathode gasket 18. The anode gasket 17 may be integrated to encapsulate upper and lower portions located in a peripheral region of the anode separator 5 and a lower portion and sides of the extension portion 3a of the anode gas diffusion layer 3. Likewise, the cathode gasket 18 may be integrated to encapsulate upper and lower portions located in a peripheral region of the cathode separator 6 and an upper portion and sides of the extension portion 4a of the cathode gas diffusion layer 4.

Therefore, according to the exemplary embodiments of the present invention, the gaskets 17 and 18 of different materials is integrated with the anode separator 5 and the cathode separator 6 through an injection molding process to improve sealing stability at low temperatures and a long-term stability at high temperatures in a cell integrated with a conventional single material and evenly securing sealing stability (or the cold resistance) at low temperatures, long-term stability at high temperatures, injection molding properties, and resistance to elution of impurities, which are the required physical properties of a gasket for fuel cells. Moreover, since the anode and cathode gaskets 17 and 18 of different materials are used, they are easily distinguished and managed from the exterior of the stack by using different colors thereof.

In addition, the anode and cathode gaskets 17 and 18 are separately integrated with the anode and cathode separators 5 and 6, making the structures and properties of the anode gasket 17 and the cathode gasket 18 different and thus providing multi-characteristic gaskets 17 and 18.

As such, the gasket device for the fuel cell stack according to the present invention has the following advantages:

First, the anode and cathode gaskets of different materials are integrated with the anode separator and the cathode separator through an injection molding process to maintain a proper seal at low temperatures and long-term stability at high temperatures in a cell integrated with a conventional single material while evenly securing sealing stability (or the cold resistance) at low temperatures, use stability at high temperatures, injection molding properties, and resistance to elution of impurities, which are the required physical properties of a fuel cell stack gasket.

Second, by manufacturing the anode gasket and the cathode gasket, the manufacturing process may independently control molding and crosslinking conditions, thus allowing the required physical properties of each of the anode and cathode gaskets may be easily obtained.

Third, different colors may be applied to the anode gasket and the cathode gasket by using different materials for the anode gasket and the cathode gasket, so that the anode gasket and the cathode gasket may be easily distinguished by merely looking at the exterior of the stack and thus they may be easily managed.

Finally, the anode gasket and the cathode gasket are separately integrated with the anode and cathode gas diffusion layers or separators for different structures of the anode and cathode gaskets, thereby providing multi-characteristic gaskets.

While the embodiments of the present invention have been described in detail, the scope of the present invention is not limited to the foregoing embodiment and various modifications and improves made by those of ordinary skill in the art using the basic concept of the present invention defined in the appended claims are also included in the scope of the present invention.

[Description of Reference Numerals]

| | |
|---|---|
| 1: Electrolyte Membrane | 2: Membrane Electrode Assembly |
| 3: Anode Gas Diffusion Layer | 4: Cathode Gas Diffusion Layer |
| 3a, 4a: First Extension Portion | 3b, 4b: Second Extension Portion |
| 5: Anode Separator | 6: Cathode Separator |
| 7, 17: Anode Gasket | 8, 18: Cathode Gasket |
| 9: Manifold | |

What is claimed is:

1. A gasket device for a fuel cell stack that is integrated with gas diffusion layers or separators,
wherein the gas diffusion layers are comprised of an anode gas diffusion layer and a cathode gas diffusion layer,
the separators are comprised of an anode separator and a cathode separator, and
the gasket device has an anode gasket and a cathode gasket that are integrated with the anode gas diffusion layer and the cathode gas diffusion layer or with the anode separator and the cathode separator, respectively,
wherein the anode gasket and the cathode gasket are composed of different materials.

2. The gasket device of claim 1, wherein the anode gasket and the cathode gasket are composed of different materials selected from a group consisting of a fluoroelastomer, a silicone elastomer, and a hydrocarbon elastomer.

3. The gasket device of claim 1, wherein the anode gasket and the cathode gasket are composed of a general shape in which the anode gasket and the cathode gasket are separately formed on upper and lower portions located in a peripheral region of the anode separator and the cathode separator, an encapsulation shape in which upper, lower, and side portions are located in a peripheral region of the anode and cathode separators are encapsulated with the anode and cathode gaskets, respectively, and a hybrid shape that is a combination of the general shape and the encapsulation shape.

4. The gasket device of claim 1, wherein the anode gasket and the cathode gasket are different colors.

5. The gasket device of claim 1, wherein the anode gasket and the cathode gasket are composed of a fluoroelastomer and a hydrocarbon elastomer, or the hydrocarbon elastomer and the fluoroelastomer, respectively.

6. The gasket device of claim 1, wherein the anode gasket and the cathode gasket are composed of a fluoroelastomer and a silicone elastomer, or the silicone elastomer and the fluoroelastomer, respectively.

7. The gasket device of claim 1, wherein the anode gasket and the cathode gasket are composed of a silicone elastomer and a hydrocarbon elastomer, or the hydrocarbon elastomer and the silicone elastomer, respectively.

8. The gasket device of claim 2, wherein the fluoroelastomer is composed of one of or a mixture of FKM and FFKM.

9. The gasket device of claim 2, wherein the silicone elastomer is composed of one of or a mixture of polydimethylsiloxane and fluorosilicone.

10. The gasket device of claim 2, wherein the hydrocarbon elastomer uses one of ethylene Ethylene-Propylene Diene Monomer (EPDM), Ethylene-Propylene Rubber (EPR), Isoprene Rubber (IR), and Isobutylene-Isoprene Rubber (IIR) alone or a mixture of two or more kinds thereof.

11. A gasket device for a fuel cell stack integrated with gas diffusion layers and separators, wherein the gas diffusion layers are comprised of an anode gas diffusion layer and a cathode gas diffusion layer,
the separators are comprised of an anode separator and a cathode separator, and
the gasket device are comprised of an anode gasket that is integrated with the anode gas diffusion layer and the anode separator, and a cathode gasket that is integrated with the cathode gas diffusion layer and the cathode separator, in which the anode gasket and the cathode gasket are composed of different materials.

12. A fuel cell vehicle including a fuel cell stack having a plurality of cells, wherein each cell includes a membrane electrode assembly, a gasket device, gas diffusion layers and separators, wherein the gas diffusion layers include an anode gas diffusion layer and a cathode gas diffusion layer,
the separators including an anode separator and a cathode separator, and
the gasket device including an anode gasket that is integrated with the anode gas diffusion layer and the anode separator, and a cathode gasket that is integrated with the cathode separator and the cathode separator, in which the anode gasket and the cathode gasket are composed of different materials.
